(19) United States
(12) Patent Application Publication
(10) Pub. No.: US 2013/0127585 A1
(43) Pub. Date: May 23, 2013

(54) TEMPERATURE-DEPENDENT SWITCHING MECHANISM

(71) Applicant: Marcel P. HOFSAESS, SONDERSHAUSEN (DE)

(72) Inventor: Marcel P. HOFSAESS, SONDERSHAUSEN (DE)

(21) Appl. No.: 13/681,743

(22) Filed: Nov. 20, 2012

(30) Foreign Application Priority Data
Nov. 22, 2011 (DE) 10 2011 119 632.7

(51) Int. Cl. H01H 37/54; H01H 49/00

(52) U.S. Cl. CPC H01H 37/54; H01H 49/00
USPC 337/333; 29/622

(57) ABSTRACT

A temperature-dependent switch has a housing which accommodates a temperature-dependent switching mechanism and which comprises an upper part with a first external connection and a lower part with a second external connection. The switching mechanism has a bimetallic snap-action disc and a spring snap-action disc having a bearing region on which a movable contact part is captively held. The contact part interacts with a first contact area provided on an inner side of the upper part, and the spring snap-action disc interacts with a second contact area provided on an inner side of the lower part. The bimetallic snap-action disc interacts with the spring snap-action disc in such a way that it lifts the movable contact part off from the first contact area depending on its temperature. The bimetallic snap-action disc is captively held with play on the contact part.

### RELATED APPLICATION

This application claims priority to German patent application DE 10 2011 119 632, filed Nov. 22, 2011, which is incorporated herein by reference.

### BACKGROUND OF THE INVENTION

The present invention relates to a temperature-dependent switching mechanism for a temperature-dependent switch having a housing which accommodates the switching mechanism and which comprises an upper part with a first external connection and a lower part with a second external connection, wherein a first contact area connected to the first external connection is provided on an inner side of the upper part and a second contact area connected to the second external connection is provided on an inner side of the lower part, wherein the switching mechanism comprises a bimetallic snap-action disc and a spring snap-action disc, on which is provided a bearing region on which a movable contact part is captively held, wherein the contact part interacts with the first contact area and the spring snap-action disc interacts with the second contact area, and wherein the bimetallic snap-action disc interacts with the spring snap-action disc in such a way that it lifts the movable contact part off from the first contact area depending on its temperature.

The present invention furthermore relates to a temperature-dependent switch comprising a temperature-dependent switching mechanism arranged in a housing which accommodates the switching mechanism and which comprises an upper part with a first external connection and a lower part with a second external connection, wherein a first contact area connected to the first external connection is provided on an inner side of the upper part and a second contact area connected to the second external connection is provided on an inner side of the lower part.

Finally, the present invention relates to a method for producing such a temperature-dependent switching mechanism, and to a method for producing such a temperature-dependent switch.

A temperature-dependent switching mechanism and a temperature-dependent switch equipped therewith of the type mentioned above are known e.g. from DE 43 45 350 A1.

The known temperature-dependent switch comprises a housing having a metallic lower part and a metallic upper part. A temperature-dependent switching mechanism is accommodated in the housing, said switching mechanism producing an electrically conductive connection between the lower part and the upper part of the housing depending on its temperature.

The switching mechanism is equipped with a spring snap-action disc and a bimetallic snap-action disc. In this case, the spring snap-action disc carries a so-called moving contact part, which presses the spring disc against a stationary contact on the inside on the upper part, which forms the first contact area. The spring snap-action disc is supported by its circumferential rim or edge on a second contact area in the lower part of the housing, such that the electric current flows from the lower part through the spring snap-action disc and the moving contact part into the stationary contact and from there into the upper part.

The lower part of the housing is configured in a pot-like fashion and it has on its inner side a circumferential shoulder on which the spring snap-action disc of the temperature-dependent switching mechanism bears.

The spring snap-action disc centrally carries a welded-on contact part, over which the bimetallic snap-action disc is slipped, such that the latter bears loosely on the spring snap-action disc.

The upper part of the housing is embodied as a cover bearing on a further circumferential shoulder of the lower part. Since lower part and upper part of the housing are produced from electrically conductive material, an insulation film is arranged between them and electrically insulates lower part and upper part of the housing from one another.

The outer side of the upper part of the housing serves as a first external connection; a first stranded wire is soldered on there. The outer side of the lower part serves as a second external connection; a connection lug onto which a second stranded wire is soldered is fixed there.

The known temperature-dependent switch serves to protect electrical loads from overheating. For this purpose, it is mounted onto the load to be protected such that it is in thermal contact with the load.

The electrical supply circuit of the load is routed via the temperature-dependent switch by one connection cable of the load being connected to one of the external connections of the switch and the other external connection of the switch being connected to the electrical supply circuit.

Owing to the thermal coupling, the temperature-dependent switch always assumes the temperature of the electrical load. If the temperature of the load now increases beyond a predefined threshold temperature, the bimetallic snap-action disc jumps to its high-temperature conformation, in which it opens the switch, such that the electrical supply circuit of the load is interrupted, which consequently cannot heat up.

In the case of this construction, the bimetallic snap-action disc below its transition temperature is mounted mechanically in a manner free of forces, the bimetallic snap-action disc also not being used for conducting the current.

In this case, it is advantageous that the bimetallic snap-action discs have a long mechanical lifetime, and that the switching point, that is to say the transition temperature of the bimetallic snap-action disc, does not change even after many switching cycles.

If less stringent requirements of the mechanical reliability or the stability of the transition temperature can be tolerated, the bimetallic snap-action disc can also concomitantly perform the function of the spring snap-action disc, such that the switching mechanism only comprises a bimetallic snap-action disc, which then carries the moving contact part and also carries the current in the closed state of the switch.

Furthermore, it is known to provide such switches with a parallel resistor connected in parallel with the external connections. When the switch is open, said parallel resistor takes over part of the operating current and holds the switch at a temperature above the transition temperature, such that the switch does not automatically close again after cooling. Such switches are called self-holding.

Furthermore, it is known to equip such switches with a series resistor through which flows the operating current flowing through the switch. Ohmic heat which is proportional to the square of the flowing current is generated in the series resistor in this way. If the current intensity exceeds a permissible amount, then the heat of the series resistor has the effect that the switching mechanism is opened.

In this way, a device to be protected is already disconnected from its electrical supply circuit when an excessively high current flow occurs which has not yet even led to excessive heating of the device.

All these different design variants can be realized with the switch according to the invention.

In its low-temperature conformation, the bimetallic snap-action disc in the case of the known switch is located freely in the switching mechanism; the spring snap-action disc is supported by its edge on the second contact area in the lower part.

At the same time, the spring snap-action disc presses the moving contact part against the first contact area, such that an electrically conductive connection between the also conductive upper part and the likewise conductive lower part is produced via the fixed contact part and the spring snap-action disc.

If the temperature of the bimetallic snap-action disc now increases above its transition temperature, said disc presses with its edge against the inner side of the upper part and in this case presses with its inner region the moving contact part away from the fixed contact part against the force of the spring snap-action disc, with the result that the temperature-dependent switch is opened.

This function can only be reliably tested if the switch has been completely mounted.

This is associated with the immediately evident disadvantage that the entire switch has to be rejected both in the case of problems with the contact-making of the moving contact part and/or the spring snap-action disc and in the case of a malfunction or faulty installation of the bimetallic snap-action disc.

Although the known temperature-dependent switching mechanism and the known temperature-dependent switch equipped therewith functionally satisfy all the requirements, there is therefore a need to improve the test possibility and producability.

A further disadvantage in the case of the known switch can be seen in the fact that at least the lower part of the housing has to be manufactured very precisely in order that the spring snap-action disc can be supported by its edge securely on the circumferential shoulder. Against this background, the lower parts of the known temperature-dependent switch are turned parts, which admittedly means high-precision manufacture, but is associated with high production and part costs.

DE 197 05 154 A1 discloses a temperature-dependent switch whose housing upper part and housing lower part are produced from electrically insulating material. An electrode is in each case arranged on the inside of the housing upper part and on the inside of the housing lower part, wherein a connecting web is riveted onto one of the electrodes by means of a rivet, the spring snap-action disc being arranged at the other end of said connecting web.

The spring snap-action disc centrally carries a moving contact part, which is inserted into an opening into the spring snap-action disc and is supported by a lower shoulder on the spring snap-action disc.

Said shoulder of the contact part is formed on a thickened flange, on the upper shoulder of which the loosely inserted bimetallic snap-action disc is supported.

The moving contact part interacts with a contact area on the second electrode, which is arranged on the inner side of the cover part.

The known switch has extremely small dimensions, but it is restricted with regard to the connection technology.

Generally, it is also known from DE 197 27 197 A1, for example, in the case of a temperature-dependent switch, to provide two fixed mating contacts in an insulating cover part, which interact with a current transfer element which is moved in a temperature-dependent manner by a temperature-dependent switching mechanism.

The temperature-dependent switching mechanism comprises a spring snap-action disc and a bimetallic snap-action disc, which are fixed to the current transfer element by means of a rivet.

In this way, current transfer element, bimetallic snap-action disc and spring snap-action disc constitute a unit, which can be inserted altogether into the lower part of the housing when the known switch is intended to be mounted.

In the case of this switch, too, it is disadvantageous that a functional test both of the switching mechanism and of the switch is possible only when the switch has been completely mounted.

Document DE 10 2007 014 237 A1 discloses a temperature-dependent switch having a temperature-dependent switching mechanism which comprises a spring tongue supported by a frame, which spring tongue carries a movable contact part and a bimetallic snap-action disc. In one embodiment, the movable contact part is arranged at the free end of the spring tongue, whereby the bimetallic snap-action disc is arranged centrally to the spring tongue and is captively connected therewith by means of a rivet bolt.

Document DE 195 45 997 A1 discloses a temperature-dependent switch wherein a temperature-dependent switching mechanism with bimetallic snap-action disc and spring snap-action disc is arranged. In one embodiment, there is provided at the inner side of the cover of the upper part of the switch a pinion onto which the spring snap-action disc and the bimetallic snap-action disc are slipped. The head of the pinion is enlarged to hold both discs at said cover. This switch does not use a movable contact part.

### SUMMARY OF THE INVENTION

In view of the above, it is one object of the present invention to improve the known temperature-dependent switching mechanism and the temperature-dependent switch equipped therewith in such a way that simple and inexpensive assembly is possible in conjunction with low production costs.

In the case of the known temperature-dependent switching mechanism, this and other objects are in one embodiment achieved by the fact that the bimetallic snap-action disc is captively held with play on the contact part.

Since spring snap-action disc, bimetallic snap-action disc and moving contact part now form a unit, the switching mechanism can be assembled and temporarily stored as a separate semifinished part, in which case separate testing of the switching mechanism is also possible since the bimetallic snap-action disc is captively held but has corresponding play, such that it can deform between its low-temperature conformation and high-temperature conformation without any hindrance.

This unhindered deformability of the bimetallic snap-action disc does not arise in the case of the switching mechanism with current transfer element as known from DE 197 27 197 A1 precisely because there the current transfer element has approximately the same transverse dimensions as the bimetallic snap-action disc and bears closely against the latter, such that the switching action can actually only be checked in the assembled state.

In the case of the switching mechanism according to the invention, by contrast, the situation is such that the moving contact part is fixed centrally on the spring snap-action disc and centrally carries the bimetallic snap-action disc, such that the latter can snap over upwards and downwards arbitrarily at its edge.

The switching mechanism can thus still be tested prior to being incorporated into the switch, such that the switches that are subsequently equipped with the switching mechanism and fully assembled themselves only have to be tested for continuity; renewed monitoring of the—temperature-dependent—switching function is not necessary.

In the case of the known temperature-dependent switching mechanism, this and other objects are in another embodiment achieved by the fact that the bearing region is separated from the spring snap-action disc by a gap extending over a part of its circumferential region, wherein the circumferential region is furthermore preferably greater than or equal to 180°.

According to another object, the contact part is welded onto the bearing region.

In the case of this measure it is advantageous that as a result of the contact part being welded onto the bearing region of the spring snap-action disc, no strains arise in the spring snap-action disc, in contrast—according to the finding of the inventor of the present application—to the case for the switch from DE 43 45 350 A1, where the bearing region is formed integrally with the spring snap-action disc.

If said bearing region is now separated partly from the spring snap-action disc either before or after the welding-on of the moving contact part e.g. by way of a gap or cut spanning a circle segment, then the internal strains are limited to the bearing region and do not extend over the entire spring snap-action disc.

These internal stresses which occur during the welding-on of a moving contact in the prior art can have the effect that the spring snap-action disc does not function as envisaged, in particular does not automatically jump back again to the closed position if the bimetallic snap-action disc has been cooled below its transition temperature again.

In other words, a spring snap-action disc provided with internal stresses can fail either during the opening of the switch or during the renewed closing of the switch by virtue of the fact that said spring snap-action disc opposes the snapping-over bimetallic snap-action disc with such a large counterforce that it cannot lift the moving contact off from the fixed contact. In this case, it is also possible that the spring snap-action disc, after snapping over to its concave form, into which it is pressed by the bimetallic snap-action disc if the latter is heated to a temperature above its transition temperature, cannot automatically leave it again and assume the convex closed position.

According to the finding of the inventor of the present application, these problems with the spring snap-action discs can astonishingly be avoided by the bearing region of the welded-on contact part being at least partly separated from the spring snap-action disc surrounding it.

This separation can be effected by a cut or gap, wherein it is important that this separation has the effect that internal strains in the bearing region do not or do not completely spread into the spring snap-action disc.

Although, according to the invention, a further manufacturing step is thus necessary during the production of a temperature-dependent switching mechanism and of a switch equipped therewith, the overall production costs nevertheless decrease because rejects can be reduced.

The measure of fixing, preferably welding, the contact part to a bearing region of the spring snap-action disc, said bearing region being at least partly separated from the spring snap-action disc, together with the generic switching mechanism even without the captively held bimetallic snap-action disc constitutes one embodiment of the invention.

By virtue of the bearing region partly separated from the spring snap-action disc, for the first time a spring snap-action disc with welded-on contact part can be provided without there being generated in the spring snap-action disc as a result of the welding process internal strains that could impair, or make impossible, the switching function of the spring snap-action disc.

Preferably, in such a switching mechanism, too, the bimetallic snap-action disc can be captively held on the contact part.

According to another object, a collar is provided on the contact part, said collar engaging through the bimetallic snap-action disc.

This measure is structurally advantageous since it enables the bimetallic snap-action disc to be fixed to the contact part in a simple manner. Specifically, the bimetallic snap-action disc is merely slipped by its central opening over the collar, whereupon the collar is subsequently widened, such that the bimetallic snap-action disc is movable with play between the collar and the flange via which the moving contact part is welded onto the bearing region of the spring snap-action disc.

According to a further object, a lateral connecting web is provided on the spring snap-action disc, via which web said disc is connected to a transport strip during the assembly of the switching mechanism.

In the case of this measure it is advantageous that the spring snap-action discs do not have to be separated before the assembly of the switching mechanism.

It is known that the spring snap-action discs, which are provided as bulk material, can be separated only with difficulty owing to electrostatic adhesion forces, with the result that this part of the production method is complex.

By contrast, if the spring snap-action disc is stamped out as it were on a strip and in this case remains connected to the transport strip via a connecting web, then the complete switching mechanism can be assembled while the spring snap-action disc is still connected to the transport strip and can thus be easily handled and manipulated.

This measure also enables the finished assembled switching mechanism to be tested in a very simple manner, specifically because the individual switching mechanisms on the transport strip merely have to be led successively through a heating chamber and through a cooling chamber, wherein a check is then made by means of contact tips, in an optical or acoustical fashion, to determine wither the bimetallic snap-action discs deform in a temperature-dependent manner in this case.

The connecting web therefore enables even simpler checking of the temperature-dependent switching mechanism before the latter is mounted in a switch.

Rejects are reduced in this way, and higher production stability can furthermore be ensured.

The switching mechanism can then be separated by the connecting web being separated from the transport strip. This separated switching mechanism can then be stored as a semifinished part or, if appropriate, be sold to corresponding customers.

By means of the connecting web, these temperature-dependent switching mechanisms can easily be handled and also inserted into corresponding lower parts of housings.

According to one embodiment, the connecting web in an assembled switch is mechanically fixed, preferably welded, to the second contact area.

This provides for a permanent electrical connection between the spring snap-action disc and the second external connection, which is electrically connected to the second contact area on the inner side of the lower part.

Since the spring snap-action disc is now permanently electrically and mechanically connected to the lower part via the connecting web, the lower part itself can be manufactured as a deep-drawn part; it is no longer necessary to use expensive turned parts.

A further advantage is that now the spring snap-action disc, which usually consists of steel, no longer has to be silver-plated in order to bring about a low contact resistance with respect to the second contact area.

Furthermore, it is also no longer necessary to silver-plate the contact area on the inner side of the lower part, and so an inexpensive deep-drawn part and a likewise inexpensive stamped part composed of steel can be used as spring snap-action disc and housing lower part, respectively.

This reduces not only the material costs but also the manufacturing costs, a relatively low contact resistance between the spring snap-action disc and the lower part of the housing nevertheless being ensured.

As seen overall, therefore the novel switching mechanism enables inexpensive, reliable production, wherein the switching mechanism can be tested for the switching function prior to being mounted into the temperature-dependent switch, that is to say outside the housing.

The novel temperature-dependent switching mechanism can also be separated from the connecting web at the spring disc, such that the switching mechanism is available as a unit, but without a connecting web, after testing.

This novel temperature-dependent switching mechanism can then be incorporated into the known housing of known temperature-dependent switches. By way of example, it can be used in the housing in accordance with DE 43 45 350 A1.

In order to ensure the low contact resistances required, it may then be necessary, however, to silver-plate the spring snap-action disc.

In the case of the known temperature-dependent switch, the object is achieved according to the invention by the fact that the novel temperature-dependent switching mechanism is incorporated into this temperature-dependent switch.

In this case, according to another object, the lateral connecting web is provided on the spring snap-action disc, wherein the lower part is a deep-drawn part to whose inner side the connecting web is fixed, preferably welded.

This affords the advantage already described that the material and production costs for the novel temperature-dependent switch are significantly reduced because a turned part is not required as the lower part, and because silver-plating can be dispensed with both in the case of the spring snap-action disc and in the case of the lower part.

Furthermore, a very good production quality and a high stability of the production sequence arise in the case of this novel temperature-dependent switch because firstly the switching mechanism is tested prior to being mounted into the switch, with the result that only functional switching mechanisms are installed.

Then the permanent electrical connection of the spring snap-action disc to the second contact area ensures that the contact resistance between the spring snap-action disc and lower part is very low. A possible fault source that can occur during the final continuity testing of a finished assembled temperature-dependent switch is eliminated in this way. Specifically, in the prior art it is entirely possible that, on account of manufacturing tolerances, the contact resistance between the lower part of the housing and the spring snap-action disc is so high that the finished temperature-dependent switch has to be discarded as a reject.

Furthermore, it is preferred if a contact block is fixed to the inner side of the upper part, the first contact area being formed on said contact block, wherein the upper part is furthermore preferably a deep-drawn part.

This measure, too, is advantageous with regard to cost aspects. If the upper part is embodied as a deep-drawn part, the separate contact block, on which the first contact area is formed, can nevertheless ensure a very low contact resistance between the moving contact part on the spring snap-action disc and the contact block on the upper part of the housing.

A method for producing a temperature-dependent switching mechanism, according to one object, comprises the following steps:
a) stamping out a spring snap-action disc, which is connected to a transport strip via a connecting web,
b) partly separating a preferably centrally arranged bearing region from the spring snap-action disc,
c) fixing a contact part to the bearing region, and
d) preferably captively fixing a bimetallic snap-action disc to the contact part.

The novel temperature-dependent switching mechanism can be produced in this way, wherein the spring snap-action disc remains connected to the transport strip during the entire assembly of the switching mechanism.

According to one object, in step c) the contact part is welded onto the bearing region.

In the case of this measure it is advantageous that a mechanically stable and electrically very reliable connection between the contact part and the bearing region is ensured. Although such welding connections can lead to internal strains, this does not lead to problems according to the invention because the bearing region is partly separated from the spring snap-action disc.

According to a further object, in step d) the bimetallic snap-action disc with a central opening is slipped over a collar on the contact part and the collar is subsequently widened.

In the case of this measure it is advantageous that the bimetallic snap-action disc can be simply mounted and fixed on the moving contact part without the bimetallic snap-action disc being subjected to mechanical stresses in its central region.

Such mechanical stresses are intended to be avoided as far as possible in the case of bimetallic discs because these mechanical stresses have the effect that the switching behaviour of the bimetallic snap-action discs cannot be set in a reproducible manner or shifts in an unforeseeable manner.

The changeover of a bimetallic snap-action disc between its low-temperature conformation and its high-temperature conformation above the transition temperature, as the transition temperature is approached, is specifically performed first of all gradually; in the jargon the bimetallic snap-action disc creeps.

If the bimetallic snap-action disc is exposed to mechanical loads during this creep process, this can have the effect that the bimetallic snap-action disc ages faster or that its transition temperature shifts, both of which are undesirable during use.

The manner according to the invention in which the bimetallic snap-action disc is fixed to the contact part now firstly affords the possibility of testing the switching mechanism as such prior to mounting, and secondly the bimetallic snap-action disc is not subjected to mechanical loads.

In one embodiment, the method comprises the following further step:
e) checking the response temperature and/or the switching behaviour of the switching mechanism still connected to the transport strip via the connecting web.

It is advantageous here that the response temperature and/or the switching behaviour can be checked directly after the assembly of the switching mechanism.

According to a still further object, method for producing a temperature-dependent switch comprises the following steps:
l) providing a housing which comprises an upper part with a first external connection and a lower part with a second external connection, wherein a first contact area connected to the first external connection is provided on an inner side of the upper part and a second contact area connected to the second external connection is provided on the inner side of the lower part,
m) providing a temperature-dependent switching mechanism which comprises a bimetallic snap-action disc and a spring snap-action disc, which is connected to a transport strip via a connecting web and on which is provided a bearing region on which a movable contact part is captively held, wherein the bimetallic snap-action disc is captively held with play on the contact part,
n) separating the switching mechanism from the transport strip, and
o) inserting the switching mechanism into the lower part and closing the lower part with the upper part, such that the contact part interacts with the first contact area and the spring snap-action disc interacts with the second contact area.

According to one embodiment, in step n) the switching mechanism is separated from the connecting web, such that it can be incorporated into existing housings.

In prior art switches, the novel switching mechanism can thus replace the previous switching mechanisms and afford the advantage that the switching mechanism can now be checked before mounting, such that rejects are reduced overall.

Secondly, it is preferred if in step n) the connecting web is separated from the transport strip and in step o) the connecting web is welded onto the inner side of the lower part.

In the case of this measure it is advantageous that the connecting web, which is already used during the assembly and the testing of the novel temperature-dependent switching mechanism, also performs a double function; specifically, it is also used to connect the spring snap-action disc mechanically and electrically permanently to the second contact area on the inner side of the lower part of the housing.

As already mentioned, this leads to a very reliable switch with a low contact resistance.

Further advantages will become apparent from the description of the accompanying drawing.

It goes without saying that the features mentioned above and those yet to be explained below can be used not only in the combination respectively specified, but also in other combinations or by themselves, without departing from the scope of the present invention.

### BRIEF DESCRIPTION OF THE DRAWINGS

An embodiment of the invention is illustrated in the accompanying drawing and is explained in greater detail in the description below. In the figures:

FIG. 1 shows a schematic cross section through a novel temperature-dependent switch in which the novel temperature-dependent switching mechanism is installed;

FIG. 2 shows a plan view of the lower part of the housing for the switch from FIG. 1, the spring snap-action disc being schematically illustrated as inserted;

FIG. 3 shows in an illustration like FIG. 1 the moving contact part, wherein spring snap-action disc and bimetallic snap-action disc are shown party cut away; and

FIG. 4 shows a schematic plan view of a spring snap-action disc situated on a transport strip, a bimetallic snap-action disc and a moving contact part being illustrated alongside said spring snap-action disc.

### DESCRIPTION OF A PREFERRED EMBODIMENT

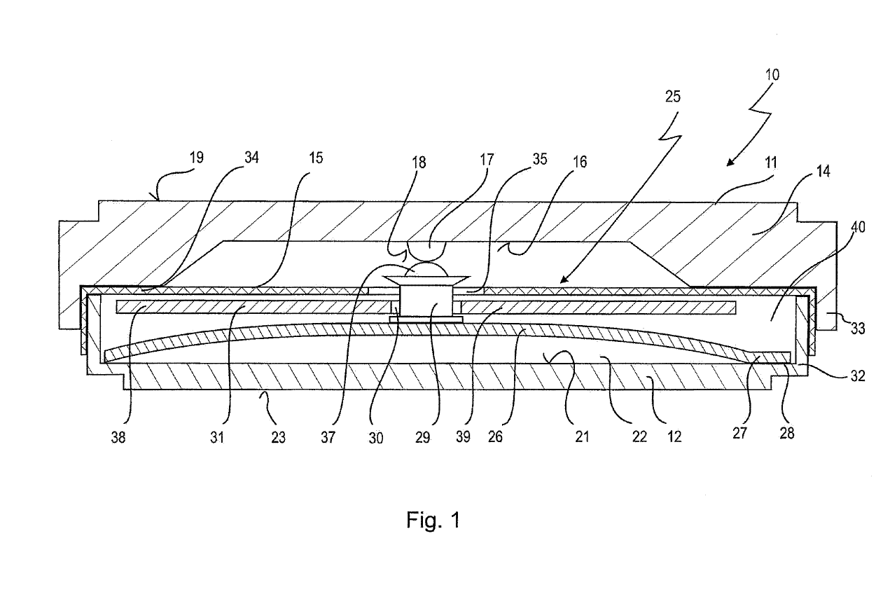

FIG. 1 shows at 10 a temperature-dependent switch comprising a housing 11, which comprises a lower part 12 produced from electrically conductive material and an upper part 14 produced from electrically conductive material.

An insulating film 15 is arranged between upper part 14 and lower part 12, and electrically insulates the upper part 14 from the lower part 12.

A fixed contact block 17 is arranged on the upper part 14 on the inner side 16 thereof, said contact block having a first contact area 18 facing towards the lower part 12.

The contact block 17 is thus electrically connected to the upper part 14, such that the outer side thereof is available as a first external connection 19.

The lower part 12 has a second contact area 22 on its inner side 21. Since the lower part 12 is likewise electrically conductive, its outer side serves as a second external connection 23.

A temperature-dependent switching mechanism 25 is arranged in the housing 11, which switching mechanism, depending on its temperature, produces an electrically conductive connection between the lower part 12 and the upper part 14 or abruptly interrupts said electrically conductive connection when a response temperature or transition temperature is exceeded.

The switching mechanism 25 has a slightly curved spring snap-action disc 26, which is integrally connected to a lateral connecting web 27, which is welded to the second contact area 22 at a welding location 28.

The spring snap-action disc 26 carries centrally a moving contact part 29, which is welded onto the spring snap-action disc 26 in a manner yet to be described.

A bimetallic snap-action disc 31 having a central opening 30 is seated with play but captively on the moving contact part 29, said bimetallic snap-action disc being situated in its low-temperature conformation in the state shown in FIG. 1, in which position it bears on the spring snap-action disc 26 in a manner free of forces.

It should also be mentioned that the lower part 12 has a circumferential wall 32 over which a circumferential wall 33 of the upper part 14 extends.

The insulating film 15 already mentioned is arranged between the two circumferential walls 32, 33, said insulating film bearing on a circumferential edge 34 of the upper part 14 and having centrally a through-opening 35, through which the moving contact part 29 projects upwards in order to come into mechanical contact with the contact block 17.

It should also be mentioned that the insulating film 15 is self-adhesive, such that after the assembly of the novel switch, if appropriate after the action of pressure of heat, it fixedly connects upper part 14 and lower part 12 to one another and protects them against ingress of contaminants of any type. Alternatively or additionally, lower part 12 and upper part 14 can also be pressed together or latched to one another.

The lower part 12 is embodied as an inexpensive deep-drawn part to which the spring snap-action disc 26 is permanently mechanically and electrically connected via the connecting web 27, such that there is a very low contact resistance between the spring snap-action disc 26 and the second external connection 23.

Since the moving contact part 29 is welded to the spring snap-action disc 26, the contact resistance between the spring snap-action disc and the moving contact part 29 is also extremely low.

The moving contact part 29 has a dome-like tip 37, which bears against the contact block 17 in the low-temperature conformation shown in FIG. 1.

By choosing a suitable surface quality of the tip 37 and of the first contact area 18 on the contact block 17, the contact resistance is very low there, too.

Consequently, the upper part 14 can likewise be an inexpensive deep-drawn part because the quality of the contact resistance is provided by the contact block 17 or the contact area 18 provided thereon.

In this way, the entire switch 10 between the first external connection 19 and the second external connection 23 has only a very low volume resistance, and so it virtually represents an electrical short circuit since two of the three possible contact resistances are replaced by welding connections.

If the temperature of the switch 10 now increases beyond the transition temperature of the bimetallic snap-action disc 31, then the latter moves with its edge 38 that is still free in FIG. 1 upwards in FIG. 1 until said edge 38 bears against the insulation film 15 where the latter is seated below the ring-shaped edge 34 of the upper part 12.

In this case, the bimetallic snap-action disc 31 presses with its central region 39 centrally onto the spring snap-action disc 26 and presses the latter downwards in FIG. 1, as a result of which the moving contact part 29 is lifted off from the contact block 17, and so the switch 10 opens.

If the ambient temperature and thus the temperature of the bimetallic snap-action disc 31 cools down below the transition temperature again, the bimetallic snap-action disc 31 returns to its low-temperature conformation shown in FIG. 1, as a result of which the opening pressure on the spring snap-action disc 26 decreases. On account of the internal forces, the spring snap-action disc 26 then jumps back again to its rest position shown in FIG. 1, in which it is braced between the inner side 21 of the lower part 12 and the contact block 17 and thus provides for a fixed contact pressure and a securely closed switch 10.

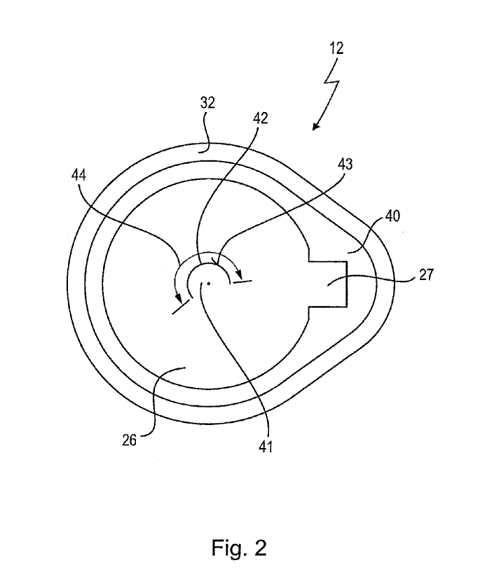

FIG. 2 illustrates a plan view of the lower part 12, wherein the end face of the circumferential wall 32 can be seen.

The plan view in FIG. 2 reveals that the lower part is embodied such that it is slightly drop-shaped with a lateral bulge 40, in which projects the connecting web 27 of the spring snap-action disc 26 indicated schematically in FIG. 2.

A bearing region 41 can be discerned centrally on the spring snap-action disc 26, said bearing region 41 being separated from the spring snap-action disc by way of a gap or cut 42.

Said gap or cut 42 extends over approximately 180° along the circumference—indicated at 43—of the bearing region 41.

The angular extension of the gap 42, that is to say that part of the circumference 43 in which it is separated from the spring snap-action disc 26, is indicated by an arrow 44 extending over an angular range of somewhat more than approximately 180°.

In this way, the bearing region 41 is still integrally connected to the spring snap-action disc 26 over at least 90% of its circumference 43.

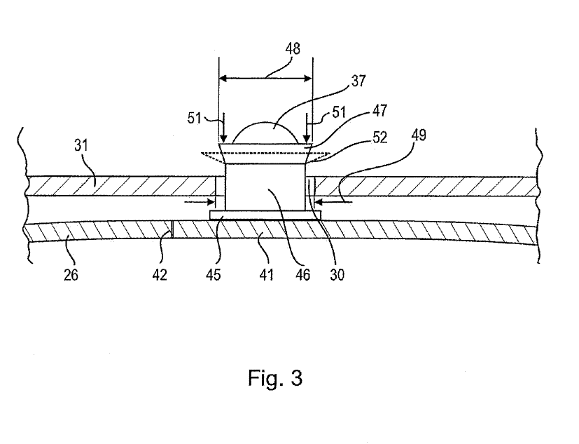

The contact part (not shown in FIG. 2) is welded onto the bearing region 41, as will now be explained in detail with reference to FIG. 3.

FIG. 3 illustrates the moving contact part 29 in an enlarged fashion. FIG. 3 furthermore illustrates the spring snap-action disc 26 and the bimetallic snap-action disc 31 party cut away.

The moving contact part 29 has a lower flange 45, which is welded onto the bearing region 41 of the spring snap-action disc 26. FIG. 3 likewise reveals the gap 42 which at least partly mechanically separates the bearing region 41 from the spring snap-action disc 26.

The flange 45 is adjoined upwards by a cylindrical extension 46, on which is seated the bimetallic snap-action disc 31 with its central opening 30.

A collar 47 is provided above the cylindrical extension 46 on the contact part 29, said collar being adjoined by the dome-like tip 37.

In the state shown in FIG. 3, the collar 47 has an external diameter—indicated at 48—which is less than the internal diameter—indicated at 49—of the central opening 30, which is in turn greater than the diameter of the extension 46, such that he bimetallic snap-action disc 31 is held with play on the contact part 29.

After the bimetallic snap-action disc 31 has been slipped by its central opening 30 over the collar 47 of the contact part 29 during the assembly of the switching mechanism 25, as illustrated in FIG. 3, the collar is spread or widened, which is illustrated by arrows 51.

In this case, the collar 47 is widened by pressing, for example, such that it assumes the configuration illustrated in a dashed manner at 52, in which it projects laterally beyond the central opening 30, such that the bimetallic snap-action disc 31 is held captively but with play on the movable contact part 29.

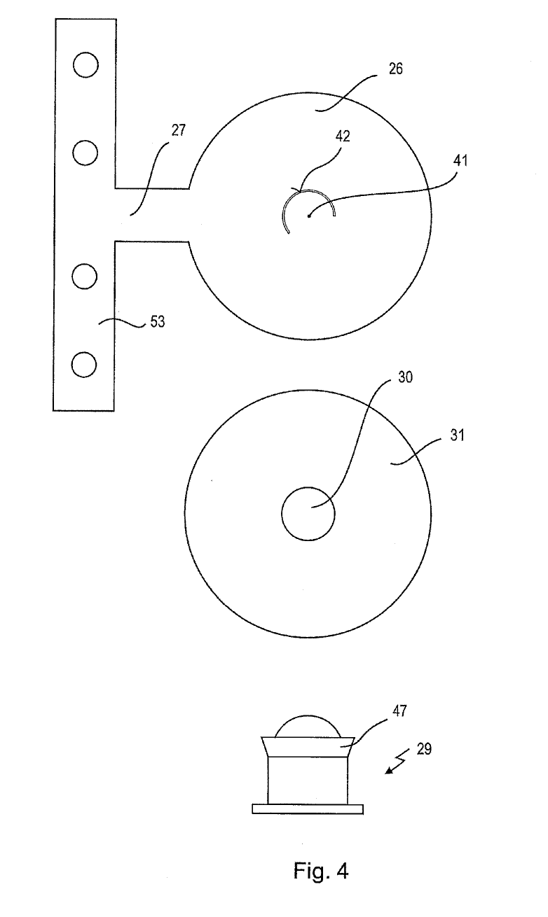

The assembly of the switching mechanism 25 will now be illustrated with reference to the basic schematic diagram from FIG. 4.

FIG. 4 shows at the top the spring snap-action disc 26 with its partly separated bearing region 41 and its connecting web 27 integrally connected to a transport strip 53.

In this way, many spring snap-action discs 26 can be stamped out alongside one another on the transport strip 53 and nevertheless remain integrally connected to the latter.

The moving contact part 29 illustrated at the bottom in FIG. 4 is now welded onto the bearing region 41. Afterwards, the bimetallic snap-action disc 31 shown in FIG. 1 is slipped by its central opening 30 over the collar 47 of the contact part 29, whereupon the collar 47 is widened such that it assumes the form indicated at 52 in FIG. 3.

A complete switching mechanism 25 composed of a spring snap-action disc 26 with welded-on contact part 29 and bimetallic snap-action disc 31 held thereon captively but with play has now been formed in this way.

This switching mechanism 25 is still connected to the transport strip 53 via the connecting web 27, such that it can now be fed to suitable test devices where the switching function of the bimetallic snap-action disc 31 can be tested whilst still outside the switch.

If a switching mechanism 25 has malfunctions, it is separated from the transport strip 53.

The other switching mechanisms are temporarily stored for further use, delivered to end customers or taken directly to an assembly line where deep-drawn lower parts 12 and deep-drawn upper parts 14 are supplied, to which the contact block 17 has already been welded in the inside.

Depending on whether substantially round upper parts and lower parts known from the prior art or else the upper parts 14 and lower parts 12 having the bulge 40 shown in FIG. 2 are used, now either the spring disc 26 is separated from the connecting web 27 or else the connecting web 27 is separated from the transport strip 53.

Switching mechanisms 25 without a connecting web 27 can be inserted into conventional housings.

Since the switching mechanisms have already been tested previously, the finished assembled switches then merely still have to be checked for electrical continuity; the switching function itself need no longer be tested.

This reduces the rejects of finished assembled switches.

By contrast, if the housing 10 in accordance with FIGS. 1 and 2 is used, the connecting web 27 is welded onto the second contact area 22 on the inside, with the result that the switching mechanism 25 is mechanically and electrically permanently connected to the lower part 12.

Besides the advantage already mentioned that the switching mechanism has already been tested previously, a further advantage is obtained here to the effect that the contact resistances in the switch are greatly reduced owing to the electrical connections between lower part 12 and spring snap-action disc 26 and between spring snap-action disc 26 and contact part 29.

Some of the malfunctions possible in a finished assembled switch are therefore ruled out, and so the rejects in the case of finished assembled switches are once again reduced, which leads to a better process stability during the production of the novel temperature-dependent switches 10.

If the contact part 29 is welded to the spring snap-action disc 26 and the spring snap-action disc 26 is welded via the connecting web 27 to the lower part 12 of the housing 11, two of the three contact resistances such as can be found in the prior art are omitted. This has the effect that two possible fault sources have also been eliminated, and so even without the captively held bimetallic snap-action disc 31, the rejects in the case of a switch 10 provided with such a switching mechanism 25 are significantly reduced.

Therefore, what is claimed is:

1. A temperature-dependent switch comprising:
a housing and a temperature-dependent switching mechanism arranged within said housing, said housing comprising an upper part having an inner side and a first external connection, and a lower part having a an inner side and a second external connection,
a first contact area connected to the first external connection being provided on said inner side of said upper part and a second contact area connected to the second external connection being provided on said inner side of said lower part,
said switching mechanism comprising a bimetallic snap-action disc and a spring snap-action disc, said spring snap-action disc being provided with a bearing region, a movable contact part secured to said bearing region, said movable contact part interacting with said first contact area and the spring snap-action disc interacting with said second contact area,
said bimetallic snap-action disc interacting with said spring snap-action disc in a temperature-dependent manner such that, depending on temperature, the bimetallic snap-action disc lifts the movable contact part off from the first contact area,
wherein the bimetallic snap-action disc is captively held with play on the contact part.

2. The switch of claim 1, wherein the contact part is welded onto the bearing region.

3. The switch of claim 2, wherein the bearing region is separated from the spring snap-action disc by a gap extending over a gap part of its circumferential region, which gap part of said circumferential region is at least equal to 180°.

4. The switch of claim 1, wherein a collar is provided on the moving contact part, said collar engaging through the bimetallic snap-action disc.

5. The switch of claim 1, wherein a lateral connecting web is provided on the spring snap-action disc, via which web said spring snap-action disc is connected to a transport strip during the assembly of the switching mechanism.

6. The switch of claim 5, wherein the connecting web is mechanically fixed to the second contact area.

7. The switch of claim 6, wherein the connecting web is welded to the second contact area.

8. The switch of claim 6, wherein the lower part is a deep-drawn part on said inner side whereof the connecting web is fixed.

9. The switch of claim 1, wherein a contact block is welded to said inner side of said upper part, said first contact area being formed on said contact block.

10. The switch of claim 9, wherein the upper part is a deep-drawn part.

11. A temperature-dependent switch comprising:
a housing and a temperature-dependent switching mechanism arranged within said housing,
said housing comprising an upper part having an inner side and a first external connection, and a lower part having a an inner side and a second external connection,
a first contact area connected to the first external connection being provided on said inner side of said upper part and a second contact area connected to the second external connection being provided on said inner side of said lower part,
said switching mechanism comprising a bimetallic snap-action disc and a spring snap-action disc, said spring snap-action disc being provided with a bearing region, a movable contact part secured to said bearing region, said movable contact part interacting with said first contact area and the spring snap-action disc interacting with said second contact area,
said bimetallic snap-action disc interacting with said spring snap-action disc in a temperature-dependent manner such that, depending on temperature, the bimetallic snap-action disc lifts the movable contact part off from the first contact area,
wherein the bearing region is separated from the spring snap-action disc by a gap extending over a gap part of its circumferential region.

12. The switch of claim 11, wherein said gap part of the circumferential region is at least equal to 180°.

13. The switch of claim 11, wherein a lateral connecting web is provided on the spring snap-action disc, via which web said spring snap-action disc is connected to a transport strip during the assembly of the switching mechanism.

14. The switch of claim 13, wherein the connecting web is mechanically fixed to the second contact area.

15. The switch of claim 11, wherein the movable contact part is welded onto the bearing region.

16. A method of producing a temperature-dependent switch, comprising the step of producing a temperature-dependent switching mechanism by:
a) stamping out a spring snap-action disc connected to a transport strip via a connecting web,
b) partly separating a bearing region from the spring snap-action disc,
c) fixing a contact part to the bearing region, and
d) fixing a bimetallic snap-action disc to the contact part.

17. The method of claim 16, wherein in step c) the contact part is welded onto the bearing region.

18. The method of 16, wherein in step d) the bimetallic snap-action disc is slipped with a central opening over a collar provided on the contact part, and the collar is subsequently widened so that it is larger than said central opening.

19. The method of claim 16, comprising the following further step:
e) checking a response temperature and/or a switching behavior of the switching mechanism while it is still connected to the transport strip via the connecting web.

20. The method of claim 16, comprising the further steps:
e) providing a housing which comprises an upper part with a first external connection and a lower part with a second external connection, wherein a first contact area connected to the first external connection is provided on an inner side of the upper part and a second contact area connected to the second external connection is provided on the inner side of the lower part,
f) separating the switching mechanism from the transport strip, and
g) inserting the switching mechanism into the lower part and closing the lower part with the upper part, such that the contact part interacts with the first contact area and the spring snap-action disc interacts with the second contact area.

21. The method of claim 20, wherein in that in step f) the switching mechanism is separated from the connecting web.

22. The method of claim 20, wherein in step f) the connecting web is separated from the transport strip and in step g) the connecting web is welded onto the inner side of the lower part.
